(19) United States
(12) Patent Application Publication
(10) Pub. No.: US 2011/0211803 A1
(43) Pub. Date: Sep. 1, 2011

(54) Multi-Medium Editing Apparatus

(75) Inventor: Chi-Chen CHENG, Taipei City (TW)

(73) Assignee: iPeerMultimedia International Ltd, Taipei City (TW)

(21) Appl. No.: 12/209,007

(22) Filed: Sep. 11, 2008

(30) Foreign Application Priority Data
Oct. 4, 2007 (TW) 096216592

(51) Int. Cl. G11B 27/00; H04N 5/775

(52) U.S. Cl. 386/230; 386/285; 386/283; 386/E05.07; 386/E05.028

(57) ABSTRACT

A multi-medium editing apparatus includes a control mechanism, an audio mechanism and a video mechanism. The control mechanism includes a processor, a first input unit connected to the processor and an output unit connected to the processor. The audio mechanism includes an audio source, a second input unit connected to the audio source and a first transfer unit for communicating the audio source with the processor. The video mechanism includes a video unit, a third input unit connected to the video unit and a second transfer unit for communicating the video unit with the processor.

### FIELD OF THE INVENTION

The present invention relates to a multi-medium editing apparatus and, more particularly, to a multi-medium editing apparatus for automatically editing and setting video data according to audio data.

### DESCRIPTION OF THE RELATED ART

To play multi-medium data with a computer, video data and audio data are received from the Internet, email or laser discs and stored in the computer. To select from and play the video data and audio data, a user uses a keyboard and/or a mouse to instruct the computer to provide the selected video data and audio data through related software interface and/or hardware interface.

However, the data include set audio data and video data. The user can only play, save, record and transfer the set audio data and video data, but cannot use and/or edit video data according to the audio data.

Therefore, the present invention is intended to obviate or at least alleviate the problems encountered in prior art.

### SUMMARY OF THE INVENTION

It is the primary objective of the present invention to provide a multi-medium edit apparatus.

According to the present invention, a multi-medium editing apparatus includes a control mechanism, an audio mechanism and a video mechanism. The control mechanism includes a processor, a first input unit connected to the processor and an output unit connected to the processor. The audio mechanism includes an audio source, a second input unit connected to the audio source and a first transfer unit for communicating the audio source with the processor. The video mechanism includes a video unit, a third input unit connected to the video unit and a second transfer unit for communicating the video unit with the processor.

Other objectives, advantages and features of the present invention will become apparent from the following description referring to the attached drawings.

### BRIEF DESCRIPTION OF THE DRAWINGS

The present invention will be described via the detailed illustration of two embodiments referring to the drawings.

FIG. 1 is a perspective view of a multi-medium editing apparatus according to the first embodiment of the present invention.

FIG. 2 is a block diagram of the multi-medium editing apparatus shown in FIG. 1.

FIG. 3 is a perspective view of a multi-medium editing apparatus according to the second embodiment of the present invention.

FIG. 4 is a block diagram of the multi-medium editing apparatus shown in FIG. 3.

### DESCRIPTION OF THE PREFERRED EMBODIMENT

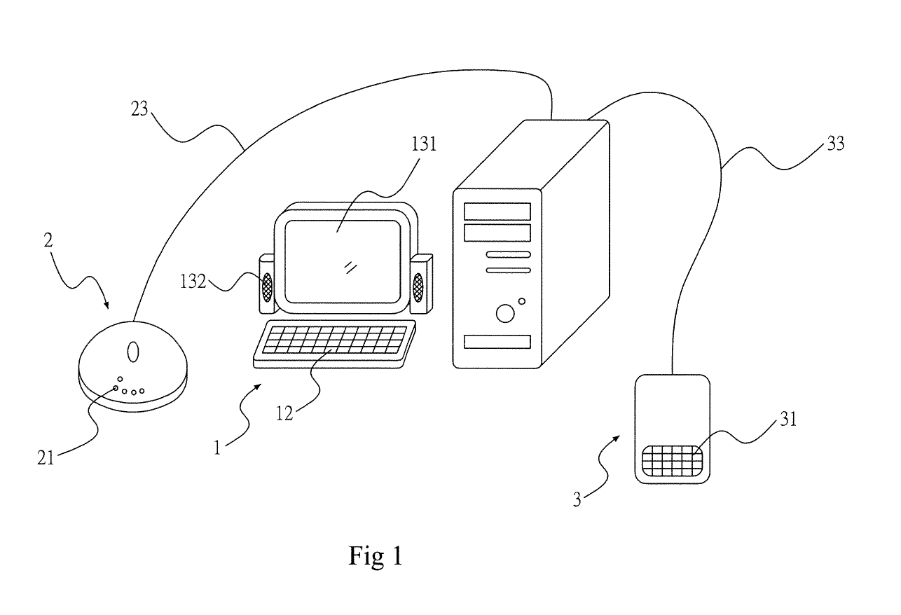

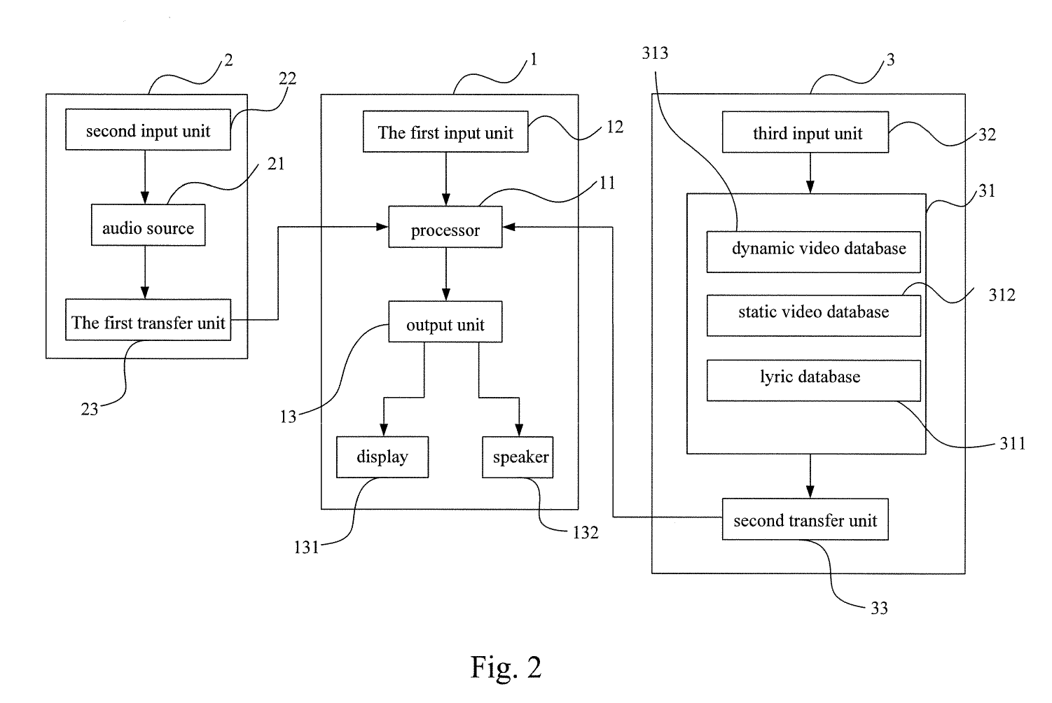

Referring to FIGS. 1 and 2, a multi-medium editing apparatus includes a control mechanism 1, an audio mechanism 2 and a video mechanism 3 according to a first embodiment of the present invention.

The control mechanism 1 may be a computer, a mobile phone or a PDA. The control mechanism 1 is preferably a computer. The control mechanism 1 includes a processor 11, a first input unit 12 connected to the processor 11 and an output unit 13 connected to the processor 11. The output unit 13 includes a display 131 and two speakers 132. The display 131 may be a television set, a TFT-LCD, LED or OLED.

The audio mechanism 2 may be a CD player, an MP3 player or any other proper audio player. The audio mechanism 2 includes an audio source 21, a second input unit 22 connected to the audio source 21 and a first transfer unit 23. The first transfer unit 23 may be a cable, a wire net, a wireless net, the infrared transmission or the Bluetooth protocol for communicating the audio source 21 with the control mechanism 11.

The video mechanism 3 includes a video unit 31, a third input unit 32 connected to the video unit 31 and a second transfer unit. The video unit includes a lyric database 311, a static video database 312 and a dynamic video database 313. The second transfer unit 33 may be a cable, a wire net, a wireless net, the infrared transmission and the Bluetooth protocol for communicating the video unit 31 with the control mechanism 11.

In operation, the second input unit is operated to select pieces from audio data stored in the audio source 21. The third input unit 32 is operated to select pieces from video data stored in the video source 31. The selected pieces of video data may be selected from the lyric database 311, the static video database 312 and/or the dynamic video database 313. The selected pieces of video data are edited based on the time of the output of the selected pieces of audio data or the frequency at the time of the output of the selected pieces of audio data. Then, the selected pieces of audio data are transferred to the processor 11 through the first transfer unit 23 while the selected pieces of video data are transferred to the processor 11 through the second transfer unit 33. The first input unit 12 is operated to instruct the control mechanism 1 to play the selected pieces of audio data through the speakers 132 and the selected pieces of video data through the display 131. Because the edition is completed, when a specific piece of audio data is played or a specific frequency of video data occurs, there is played a specific piece of video data such as lyrics, photographs and footages. Therefore, the video mechanism 3 edits the selected pieces of video data based on the selected pieces of audio data.

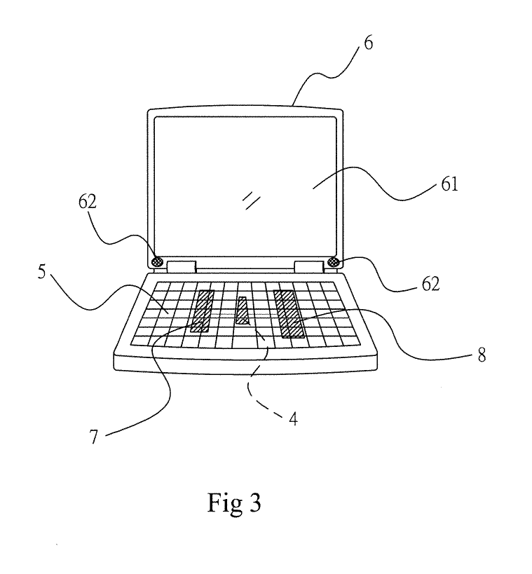

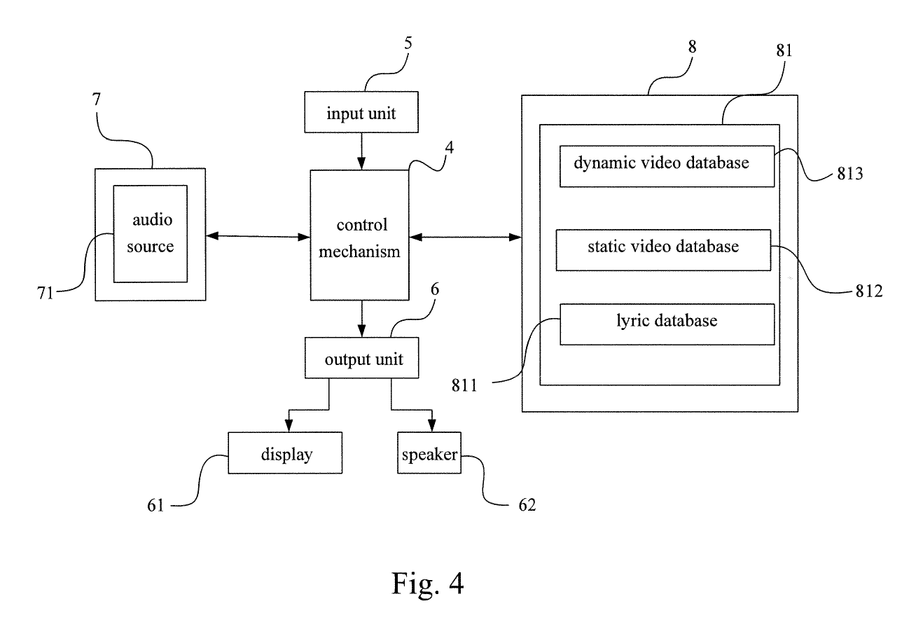

Referring to FIGS. 3 and 4, there is shown a multi-medium editing apparatus according to a second embodiment of the present invention. The second embodiment is in the form of an SOC for use in a computer, a mobile phone or a PDA. The SOC includes a control mechanism 4, an input unit 5 connected to the control mechanism 4, an output unit 6 connected to the control mechanism 4, an audio mechanism 7 connected to the control mechanism 4 and a video mechanism 8 connected to the control mechanism 4. The output unit 6 includes a display 61 and two speakers 62. The audio mechanism 7 includes an audio source 71. The audio source 71 may provide audio data in the CD format, the VCD format, the DVD format, the MP3 format and the MPEG II format. The video mechanism includes a video unit 81. The video unit 81 includes a lyric database 811, a static video database 812 and a dynamic video database 813.

In operation, the input unit 5 is operated to select pieces from audio data stored in the audio source 71. Pieces are selected from video data stored in the video unit 81. The selected pieces of video data may be selected from the lyric database 811, the static video database 812 and/or the dynamic video database 813. The selected pieces of video data are edited based on the time of the output of the selected pieces of audio data or the frequency at the time of the output of the selected pieces of audio data. The selected pieces of audio data are played by the speakers 62 and the selected pieces of video data are played on the display 61. Because the edition is completed, when a specific piece of audio data is played or a specific frequency of video data occurs, a specific piece of video data is played such as lyrics, photographs and footages. Therefore, the video mechanism 8 edits the selected pieces of video data based on the selected pieces of audio data stored in the audio mechanism 7.

There are some advantages of the multi-medium editing apparatus. Firstly, the operation is efficient because there is no need to store the driver software for the player 3 and the multi-medium data in the control mechanism 1. Secondly, the operation is secure because it is difficult to steal the multi-medium data from the player 3.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A multi-medium editing apparatus comprising:
a control mechanism comprising a processor, a first input unit connected to the processor and an output unit connected to the processor;
an audio mechanism comprising an audio source, a second input unit connected to the audio source and a first transfer unit for communicating the audio source with the processor;
a video mechanism comprising a video unit, a third input unit connected to the video unit and a second transfer unit for communicating the video unit with the processor.

2. The multi-medium editing apparatus according to claim 1, wherein the control mechanism is a computer.

3. The multi-medium editing apparatus according to claim 1, wherein the control mechanism is a mobile phone.

4. The multi-medium editing apparatus according to claim 1, wherein the control mechanism is a PDA.

5. The multi-medium editing apparatus according to claim 1, wherein the output unit comprises a display and at least one speaker.

6. The multi-medium editing apparatus according to claim 1, wherein the audio source provides audio data in a format selected from a group consisting of the CD format, the VCD format, the DVD format, the MP3 format and the MPEG II format.

7. The multi-medium editing apparatus according to claim 1, wherein the video unit comprises a lyric database, a static video database and dynamic video database.

8. The multi-medium editing apparatus according to claim 1, wherein the first and second transfer units are cables.

9. The multi-medium editing apparatus according to claim 1, wherein the first and second transfer units are part of a wire net.

10. The multi-medium editing apparatus according to claim 1, wherein the first and second transfer units are part of a wireless net.

11. The multi-medium editing apparatus according to claim 1, wherein the first and second transfer units are part of the infrared transmission.

12. The multi-medium editing apparatus according to claim 1, wherein the first and second transfer units are part of the Bluetooth communication.

13. A multi-medium editing apparatus comprising:
a control mechanism;
an input unit connected to the control mechanism;
an output unit connected to the control mechanism;
an audio mechanism connected to the control mechanism, the audio mechanism comprising an audio unit; and
a video mechanism connected to the control mechanism, the video mechanism comprising a video unit.

14. The multi-medium editing apparatus according to claim 13, wherein the control mechanism is a computer.

15. The multi-medium editing apparatus according to claim 13, wherein the control mechanism is a mobile phone.

16. The multi-medium editing apparatus according to claim 13, wherein the control mechanism is a PDA.

17. The multi-medium editing apparatus according to claim 13, wherein the output unit comprises a display and at least one speaker.

18. The multi-medium editing apparatus according to claim 13, wherein the audio source provides audio data in a format selected from a group consisting of the CD format, the VCD format, the DVD format, the MP3 format and the MPEG II format.

19. The multi-medium editing apparatus according to claim 13, wherein the video unit comprises a lyric database, a static video database and dynamic video database.
